(19) United States
(12) Patent Application Publication
(10) Pub. No.: US 2009/0297064 A1
(43) Pub. Date: Dec. 3, 2009

(54) METHOD AND SYSTEM FOR GENERATING A REPRESENTATION SYMBOL AS AN IDENTIFICATION CHALLENGE

(76) Inventors: Jason D. Koziol, Naperville, IL (US); Anthony R. Koziol, Gainesville, FL (US)

Correspondence Address: Daniel W. Roberts;Law Office Of Daniel W. Roberts, 904 Topaz Street, Superior, CO, 80027-6044, US

(21) Appl. No.: 12/129,809

(22) Filed: May 30, 2008

(51) Int. Cl. G06K 9/54

(52) U.S. Cl. 382/302

(57) ABSTRACT

Provided is a system and method for generating a representation of a symbol. The method includes receiving a base image symbol. The base image symbol is distinguished into a plurality of initial image components. The initial image components are mapped to a first plane defined by two perpendicular axes, a third axis being normal to the plane. A noise function is selected. A plurality of views are generated, each by applying the selected noise function to each initial image component to provide an adjusted image component, each adjusted image component offset from initial image component. The adjusted image components are collectively orthogonally projected into a viewing plane angled relative to the first plane. The plurality of views are output such as to a database or a display. An associated system for performing the method is also provided.

### FIELD OF THE INVENTION

The present invention relates generally to data security and more particularly to methods and systems for generating a representation of a symbol that poses an identification challenge.

### BACKGROUND

Sensitive data, such as for example, email addresses, phone numbers, residence addresses, usernames, user passwords, social security numbers, credit card numbers and/or other personal information are routinely stored on computer systems. Individuals often use personal computers to store bank records and personal address listings. Web servers frequently store personal data associated with different groups, such as clients and customers. In many cases, such computers are coupled to the Internet or other network which is accessible to other users and permits data exchange between different computers and users of the network and systems.

Connectivity to the Internet or other network often exposes computer systems to malicious autonomous software applications or automated agents. Automated agents are typically generated by autonomous software applications that operate to “appear” as an agent for a user or a program. Real and/or virtual machines are used to generate automated agents that simulate human user activity and/or behavior to search for and gain illegal access to computer systems connected to the Internet or other network, retrieve data from the computer systems and generate databases of culled data for unauthorized use by illegitimate users.

Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents, and agents composed of sub-agents where the sub-agents themselves are individual automated agents. Examples of such automated agents include, but are not limited to, viruses, Trojans, worms, bots, spiders, crawlers and keyloggers.

The increased use of computer systems that are communicatively coupled to the Internet or other networks to store and manipulate different forms of sensitive data has generated a need to format sensitive data into a form that is recognizable to a human user while posing an identification challenge to an automated agent. Storing and/or transmitting sensitive data in such a format enables human users to access the data for legitimate reasons while making it a challenge for automated agents to access the data for illegitimate reasons.

In some prior art systems, static images of sensitive data are represented in a format that includes one or more different noise components. For example, noise components in the form of various types of deformations and/or distortions are introduced into the static image representation of the sensitive data. For example, in a CAPTCHA (Completely Automated Public Turing Test to Tell Computers and Humans Apart) representation of data, noise is deliberately and/or strategically integrated into the static image representation of the sensitive data in an attempt to protect the sensitive data from automated agents that may gain unauthorized access to the data.

As the sensitive data is presented in most cases upon a computer screen, it may be described as being presented in accordance with two dimensions—a horizontal and a vertical axis. In many instances the distortion or noise element is applied so as to change one or more image elements along either the horizontal or vertical axis, or perhaps to even rotate the axis of the displayed data relative to the horizontal and vertical axis of the display.

Attempts to provide animated CAPTCHA representations of data have thus far also involved the introduction of noise elements into the sensitive data, and again have done so with respect to one axis, e.g. the image is distorted by cyclical compression along the horizontal axis while the vertical axis remains unchanged. Moreover, in at least one view of the CAPTCHA representation of the data there is at least one key view that provides a substantially clear view of all elements forming the sensitive data.

Unfortunately, continuous advances in optical character recognition technologies have operated to defeat many of the different static and animated CAPTCHA representations of sensitive data.

Hence there is a need for a method and system that is capable of generating a representation of a symbol that poses an identification challenge.

### SUMMARY

This invention provides a method and system for generating a representation symbol as an identification challenge.

In particular, and by way of example only, according to one embodiment of the present invention, a method of generating a representation of a symbol, the method including: receiving a base image symbol; distinguishing a plurality of initial image components from the base image symbol mapped to a first plane defined by a first and second axis, a third axis being normal to the first plane; selecting at least one noise function; generating a plurality of views, each view provided by: applying the selected noise function to each initial image component to provide an adjusted image component, each adjusted image component offset from initial image component; orthogonally projecting the collective adjusted image components into a viewing plane angled relative to the first plane; outputting the plurality of views for the viewing plane.

In yet another embodiment, provided is a representation symbol of a base image symbol having a plurality of initial image components, including: a plurality of adjusted image components, each adjusted image component corresponding to and offset from an initial image component; and at least one adjusted image component obscuring at least a portion of another adjusted image component.

Still in yet another embodiment, provided is a method of generating a representation of a symbol that poses an identification challenge for an automated agent, the method including: receiving a base image symbol; resolving the base image symbol into a plurality of initial image components; selecting at least one noise function; generating a plurality of views, each view provided by: applying, for each initial image component, the selected noise function to provide an adjusted image component; determining a variance between the adjusted image component and the initial image component; accepting the view in a first instance when the variance of a first percentage of the adjusted image components is above a first threshold value, and discarding the view in a second instance when the variance of the first percentage of the adjusted image components is below the first threshold value; and outputting the plurality of views.

Further still, in yet another embodiment, provided is a system for generating a representation of a symbol, including: a receiver structured and arranged with an input device for permitting at least one base image symbol to be received; a distinguisher structured and arranged to distinguish a plurality of initial image components from the base image symbol mapped to a first plane defined by a first and second axis, a third axis being normal to the first plane; a noise function structured and arranged to provide at least one noise function; a view generator structured and arranged to generate a plurality of views, each view provided by: applying the selected noise function to each initial image component to provide an adjusted image component, each adjusted image component offset from the initial image component; orthogonally projecting the collective adjusted image components into a viewing plane angled relative to the first plane; an outputter structured and arranged to output the plurality of views for the viewing plane.

And, in yet another embodiment, provided is a computer-readable medium on which is stored a computer program for generating a representation of a symbol as a challenge for an automated agent, the computer program including instructions which when executed by a computer, perform the steps of: receiving a base image symbol; distinguishing a plurality of initial image components from the base image symbol mapped to a first plane defined by a first and second axis, a third axis being normal to the first plane; selecting at least one noise function; generating a plurality of views, each view provided by: applying the selected noise function to each initial image component to provide an adjusted image component, each adjusted image component offset from initial image component; orthogonally projecting the collective adjusted image components into a viewing plane angled relative to the first plane; outputting the plurality of views for the viewing plane.

### BRIEF DESCRIPTION OF THE DRAWINGS

At least one method and system for generating a representation symbol as an identification challenge will be described, by way of example in the detailed description below with particular reference to the accompanying drawings in which like numerals refer to like elements, and:

FIG. 1 illustrates a high level block diagram of a system for generating a representation symbol from a base image symbol in accordance with at least one embodiment;

FIG. 2 is high level flow diagram according to a method of generating a representation of a symbol from a base image symbol in accordance with at least one embodiment;

FIG. 3 illustrates distinguishing a plurality of initial image components from a base image symbol and mapping them to a first plane in accordance with at least one embodiment;

FIGS. 4-4B illustrate the application of a noise function to the end points and control points of the initial image components in accordance with at least one embodiment;

FIGS. 5-5B illustrate the rendering of adjusted image components collectively providing a view in accordance with at least one embodiment;

FIGS. 6-6B illustrate the second instance of the application of a noise function to the end points and control points of the initial image components in accordance with at least one embodiment;

FIGS. 7-7B illustrate the rendering of adjusted image components collectively providing a second view in accordance with at least one embodiment;

FIG. 8 illustrates the orthogonal projection of an adjusted image component from the first plane to a viewing plane in accordance with at least one embodiment;

FIG. 9 is a refined flow diagram of the generation of adjusted image components collectively providing a view in accordance with at least one embodiment;

FIG. 10 presents an example of a block base image symbol processed to provide multiple representation views in accordance with at least one embodiment;

FIG. 11 presents a conceptual summary of the generated representation views as being human only perceptible; and

FIG. 12 is a block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for generating a representation symbol as an identification challenge. Thus although the instrumentalities described herein are for the convenience of explanation shown and described with respect to exemplary embodiments, it will be understood and appreciated that the principles herein may be applied equally in other types of systems and methods involving the generation of a representation symbol as an identification challenge.

The present disclosure advances the art by providing, in at least one embodiment, a method for generating a representation symbol as an identification challenge. Moreover, in at least on embodiment a method and system are provided which provide an advantageous CAPTCHA representation which does not include a key view, e.g. a substantially clear view of all elements forming the sensitive data.

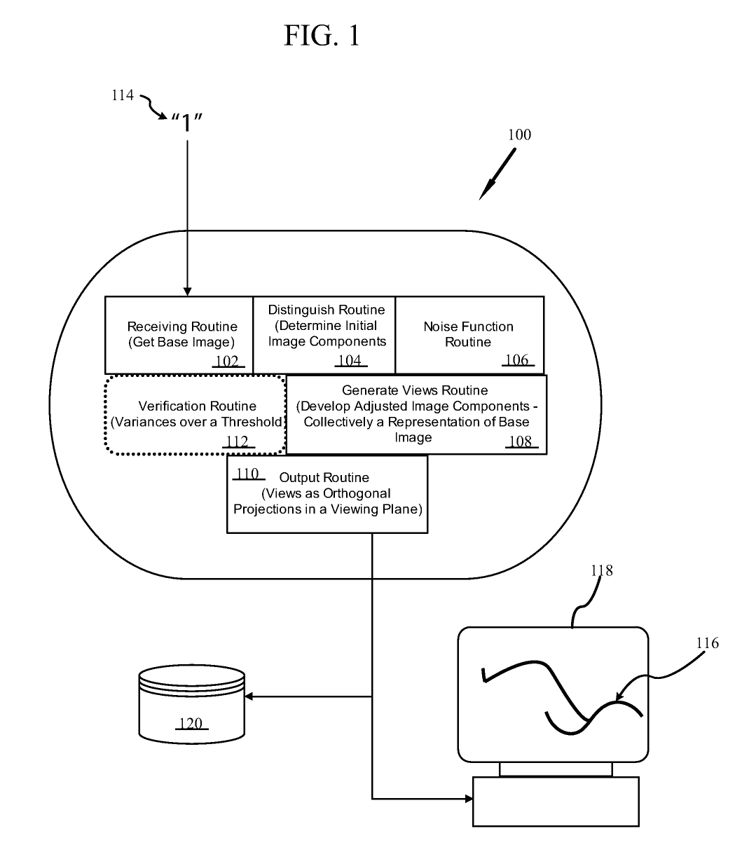

FIG. 1 is a high level block diagram of a system for generating a representation symbol (“SFGRS”) 100 that poses an identification challenge according to at least one embodiment. SFGRS 100 is shown to include a receiver, a distinguisher, a noise function, a view generator, and an outputter. More specifically with respect to FIG. 1, SFGRS 100 is conceptually illustrated in the context of an embodiment for computer program architecture. SFGRS 100 may be employed on a computer having typical components such as a processor, memory, storage devices and input and output devices. During operation, the SFGRS 100 may be maintained in active memory for enhanced speed and efficiency. In addition, SFGRS 100 may also be operated within a computer network and may utilize distributed resources.

As shown in FIG. 1, SFGRS 100 includes a receiving routine 102, a distinguish routine 104, a noise function routine 106, a generate views routine 108 and an output routine 110. In at least one embodiment, SFGRS 100 also includes a verification routine 112. As is further set forth and described below, the elements of SFGRS 100 may be summarized for at least one embodiment as follows.

The receiving routine 102 is operable to receive at least one base image symbol 114. The distinguish routine 104 is operable to distinguish a plurality of initial image components from the base image symbol 114 and map them to a first plane. The noise function routine 106 is operable to select at least one noise function and provide noise data for generating adjusted image components.

The generate views routine 108 is operable to generate a plurality of views, each view being provided by applying the provided noise data from the selected noise function to each initial image component to provide an adjusted image component, each adjusted image component being offset from the initial image component. With respect to each adjusted image component being offset from the initial image component, “offset” is understood and appreciated to be a modification from the initial image component which may be a rotation, change in size, change in color, and/or change other aspect or parameter, as well as combinations thereof, which affects the visual rendering of the adjusted image component. As is further discussed below, the offset also results in an at least one instance of overlap between at least one adjusted image component and at least a portion of another adjusted image component. In other words, the offset causes at least one adjusted image component to obscure at least a portion of another adjusted image component.

The generate views routine 108 also orthogonally projects the collective adjusted image components of each view into a viewing plane aligned relative to the first plane so as to provide the representation symbol 116.

The output routine 110 is operable to output the generated views of the representation symbol 116, such as in one embodiment to a display 118, and in at least one alternative embodiment to a database 120. The optional verification routine 112 is operable to test each generated view of the representation symbol 116 against the initial base image symbol 114 and insure that the generated view is above a threshold of variance in difference from the initial base image symbol 114.

With respect to FIG. 1, it is understood and appreciated that the elements, e.g. receiver (receiving routine 102), the distinguisher (distinguish routine 104), the noise function (noise function routine 106), the view generator (generate views routine 108), and the outputter (output routine 110) are in one embodiment located within a single device, such as for example a computer. In at least one alternative embodiment, these elements may be distributed over a plurality of interconnected devices. Further, although each of these elements has been shown conceptually as an element, it is understood and appreciated that in varying embodiments, each element may be further subdivided and/or integrated with one or more other elements.

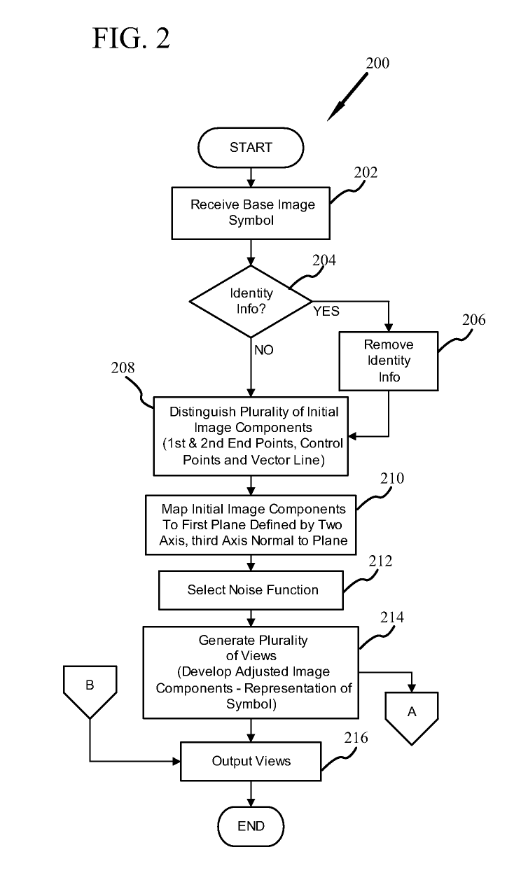

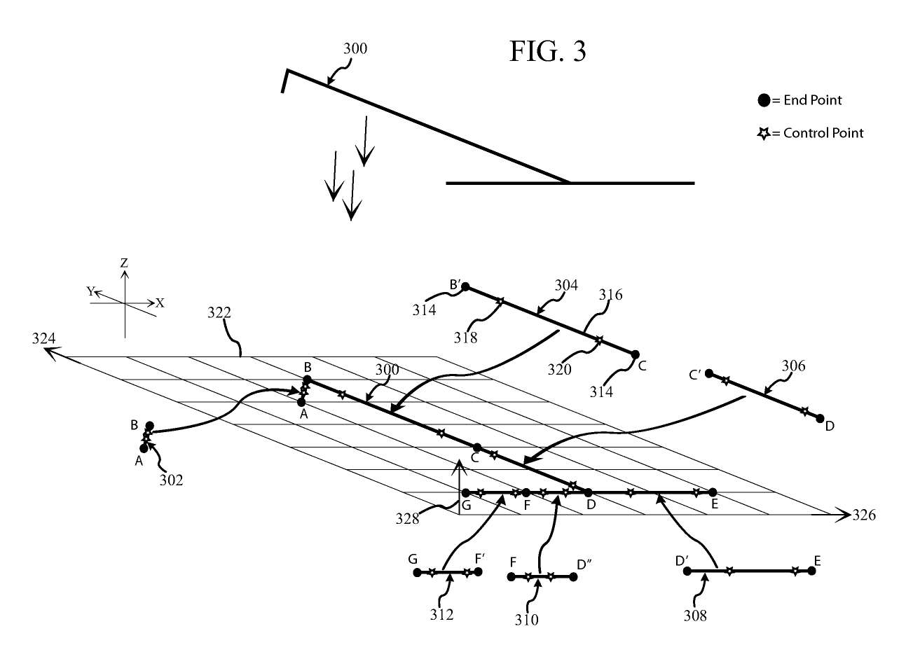

FIG. 2 in connection with FIGS. 3-9 provides a high level flow diagram with conceptual illustrations depicting a method 200 for generating a representation symbol as an identification challenge in accordance with at least one embodiment. It will be appreciated that the described method need not be performed in the order in which it is herein described, but that this description is merely exemplary of one method of generating a representation symbol as an identification challenge such as may be performed by SFGRS 100.

Moreover, in at least one embodiment the method 200 commences when a base image symbol is received, block 202. In varying embodiments, the base image symbol may be provided as an alphanumeric character, a non-alphanumeric character such as an icon, arrow, logo, figure, and or combinations thereof. In at least one embodiment the base image symbol may be provided as or with symbol identification, such as for example ASCII representation code. Alternative forms of symbol data may include, but are not limited to BMP (Windows Bitmap®), GIF (Compuserve Graphical Image Format), PNG (Portable Network Graphics), SVG (Scalable vector Graphics), VRML (Virtual Reality Markup Language), WMF (Windows MetaFile®), AVI (Audio Visual Interleave), MOV (Quicktime movie), SWF (Shockwave Flash), DirectX, OpenGL, Java, Windows®, MacOS®, Linux, PDF (Portable Document Format), JPEG (Joint Photographic Experts Group, MPEG (Moving Picture Expert Group) or the like.

If the base image symbol is provided as symbol data, the appropriate symbol associated with the data is generated. The symbol data, if provided as or with the base image symbol, is then removed, decision 204 and block 206. In at least one alternative embodiment this image identity information is stored for later use and/or reference.

The base image symbol is distinguished into a plurality of image components and mapped to a first plane, blocks 208, 210. More specifically, in FIG. 3 a base image symbol 300 as a “1” is resolved so as to distinguish a plurality of initial image components, such as exemplary initial image components 302, 304, 306, 308, 310 and 312, of which initial image component 304 is exemplary.

Each image component has two end points 314, each illustrated as a dot A˜G, with common end points indicated as a series, e.g. B and B′, D and D′ and D″. For example, initial image component 304 has first end point 314B′ and second end point 314C. Initial image component 304 has vector line 316 between first end point 314B′ and second end point 314C.

In at least one embodiment at least two control points are also provided for each initial image component, such as control points 318, 320 for image component 304. For ease of identification each control point is illustrated as a star. As indicated, initially the first and second end points 314B′, 314C and control points 318, 320 are collinear for initial image component 304 as are the respective first and second end points and control points of initial image components 306, 308, 310 and 312.

The initial image components are mapped to a first plane 322 that is defined by a first axis 324 shown conforming to the Y-axis, and a second axis 326 shown conforming to the X-axis. A third axis 328 that is normal to the first plane 322 and is shown conforming to the Z-axis. For purposes of discussion and ease of illustration the number of initial image components derived from the initial base symbol “1” is shown to be six, i.e., initial image components 302, 304, 306, 308, 310 and 312.

In general, a greater number of image components permits the resulting representation of the base image symbol 300 to pose a greater challenge for an automated agent. Moreover, whereas only the vertical trunk of the “1” is shown subdivided into two image components 304 and 306 for ease of illustration and discussion, in at least one embodiment each initial image component is determined to be no longer than a user defined length. As such the initial base image symbol 300 may be subdivided into tens, if not hundreds or thousands of initial image components.

In at least one embodiment, the vector line 316 is provided as a Bézier curve. In the mathematical field of numerical analysis, a Bézier curve is a parametric curve important in computer graphics, especially vector graphics, wherein the Bézier curve permits a smooth curve that can be scaled indefinitely. Although curves rendered by other means are applicable in varying embodiment, the commonality of Bézier curve generation easily permits the present method to be deployed in a wide variety of operating systems and applications, each potentially utilizing a different programming language, yet having in common an understanding of, and ability to generate a Bézier curve. As the end points and control points are collinear for each initial image component, the initial Bézier curve is simply a straight line between each set of first and second end point 314.

In general, it is understood and appreciated that the control points are not typically considered to be part of the rendered curve, rather they are directional points which influence the curve as it is rendered from the first end point to the second end point. In the presented figures, the locations of the control points is understood to be conceptual for ease of illustration and discussion.

As indicated in block 212, at least one noise function is selected. Moreover, in at least one embodiment, the noise function will provide a value to be applied as an axis offset for the end points and control points of each image component. Accordingly, the function will provide values within a predetermined range. In at least one embodiment a noise function is cyclical, such as a sine or cosine function, having a repeating period. Indeed the noise function may be a single function, a combination of functions, or a function of a function. In at least one alternative embodiment the noise function is non-cyclical, such as a random seed function. In yet at least one further embodiment the noise function is perturbed using random values, another function or a combination thereof. Further still the perturbed function is nondeterministic or chaotic in nature in generally following a pattern but not repeating in sequence.

As indicated in block 214, a plurality of views are now generated. More specifically, each view is provided by applying the selected noise function to each initial image component to provide an adjusted image component, each adjusted image component offset from the initial image component. Collectively, the adjusted image components provide the representation of the initial base image as a view. The developed views are then output, block 216.

Application of the noise function in accordance with at least one embodiment is performed as follows to provide adjusted image components collectively providing a view corresponding to a representation of the initial base image. Specifically, an offset is determined for each first end point, second end point and the control points of each element along at least one selected axis. The determined offset is then added to each respective first end point, second end point and control points of each element along the selected axis, common end points between elements receiving the same offset. The vector is then regenerated between each set of first and second end points as a curve. Specifically in at least one embodiment this curve is a Bézier curve. In at least one embodiment this offset is transverse to the first plane. In at least one alternative embodiment this offset is within the first plane.

Moreover, in at least one embodiment the offset to be applied to each end point and control point is at least in part derived from the initial X,Y coordinate of the respective point (e.g., end point or control point). Further, in at least one embodiment the determined offset will be applied along the Z-axis, normal to the first plane 322. In other words each point will vary within a pre-determined range along the Z-axis, a Bézier curve generated in accordance with the placement of these points. It is also understood and appreciated that as the offset varies along the Z-axis (positively and negatively), at times the determined offset may be zero. As each point (end points and control points) receives an individually determined offset, the occurrence of a zero offset is a non-issue.

Specifically, in at least one embodiment a noise function is based upon sine as applied to the (X,Y) coordinate points of each end point and control point, and provides an offset distance along the Z-axis. Further, the sine noise function in at least one embodiment permits adjustment of the amplitude (positive and negative variation), the period (duration of time) and the offset (where upon the curve of the function is the start location). Moreover, in at least one embodiment, a noise function is applied in accordance with pseudo Noise Function 1, wherein the function nextView is triggered by a passing interval of time event:

### Noise Function 1

```
var sin_per = 80;
var sin_amp = 20;
var sin_ofs = 70;
function sinDeflect2(x, y)
{
return Math.round(Math.sin((x+y−sin_ofs)/sin_per * Math.PI) *
sin_amp);
}
funct nextView (evt)
{
// for each point x,y on the base image component
lastWaveOffset = sinDeflect2( x, lastClientY + y );
      waveOffset = sinDeflect2( x, evt.clientY + y );
      z = z + waveOffset − lastWaveOffset;
}
```

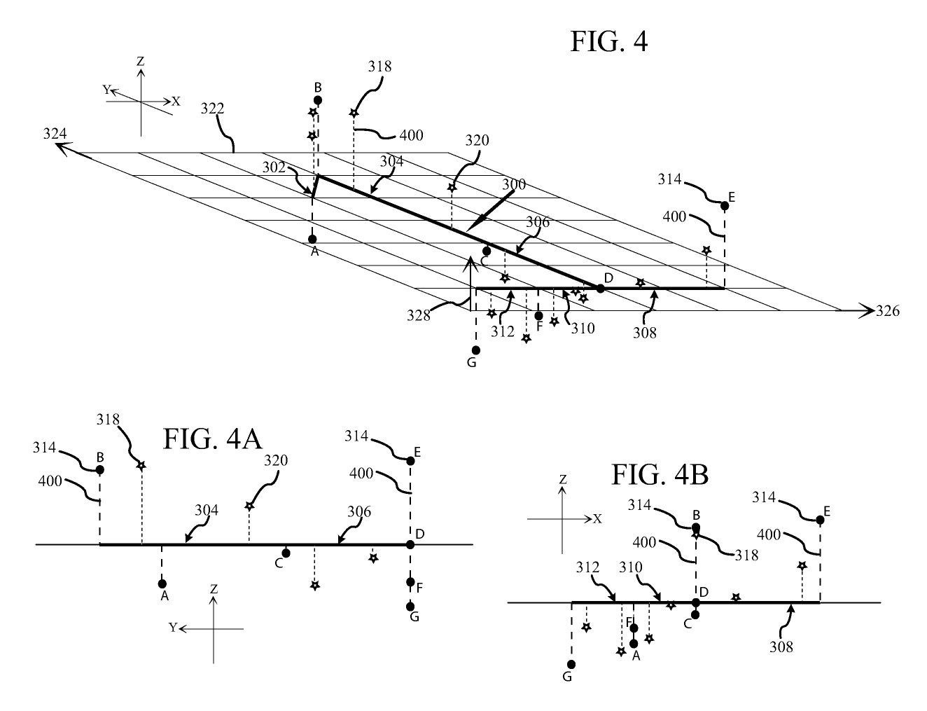

FIG. 4 conceptually illustrates the offsets 400 as applied to each of the respective first and second end points 314 (e.g. A˜G) and the control points associated there with in a perspective view. Thick dotted lines indicate the offsets for end points 314 and thin dotted lines indicate the offsets of control points, e.g. control point 318. The offsets may be further appreciated with respect to FIG. 4A showing the offset end points and control points as viewed along the X-axis to perceive the YZ plane and FIG. 4B showing the offset end points and control points as viewed along the Y-axis to perceive the ZX plane. As shown the offsets 400 are generally of varying magnitude.

In at least one embodiment, the selected noise function is applied to all end points and control points. In at least one alternative embodiment a first selected noise function is applied to all end points and a second noise function is applied to all control points. Moreover, in varying embodiments, one or more noise functions may be applied to one or more subgroups of end points, control points and/or combinations thereof. Indeed, in at least one embodiment the control points receive determined offsets that are out of phase with the determined offsets of each associated first and second end points.

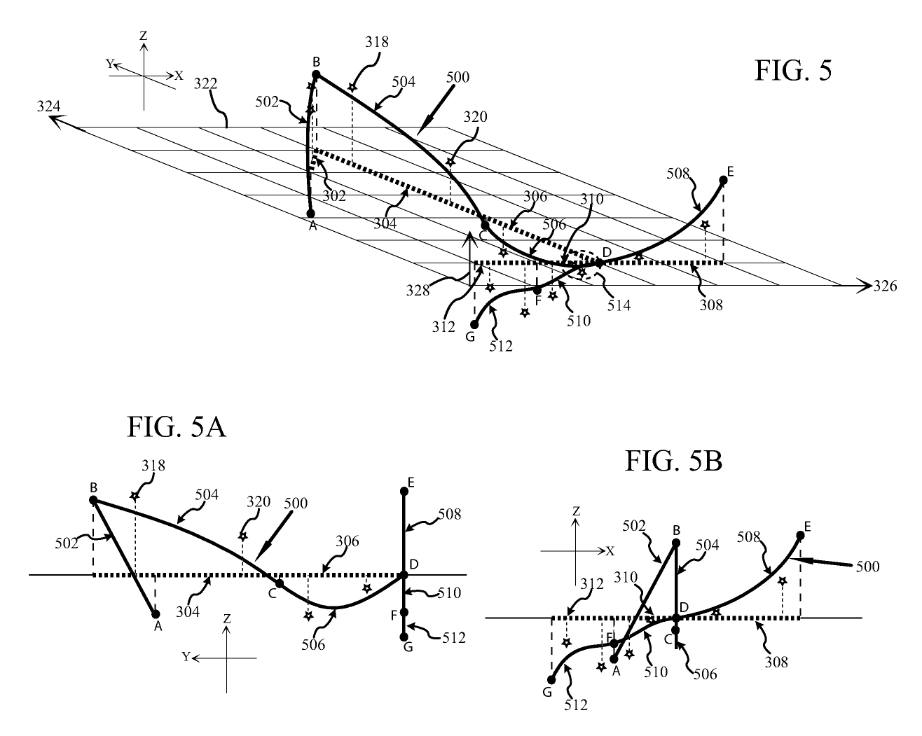

FIG. 5 conceptually illustrates the Bézier curves rendered to provide the adjusted image components 502, 504, 506, 508, 510 and 512, which collectively provide representation symbol 500. The initial image components 302, 304, 306, 308, 310 and 312 shown in dotted line relief in first plane 322.

The adjusted image components 502, 504, 506, 508, 510 and 512 may be further appreciated with respect to FIG. 5A showing the adjusted image components 502, 504, 506, 508, 510 and 512 as viewed along the X-axis to perceive the YZ plane and FIG. 5B showing adjusted image components 502, 504, 506, 508, 510 and 512 as viewed along the Y-axis to perceive the ZX plane.

In at least one embodiment, the adjusted image components are considered distorted image components. More specifically, whereas the initial base image symbol 300, e.g. the “1” shown in dotted relief has initial image components 302, 304, 306, 308, 310 and 312 appearing as straight lines, the adjusted image components 502, 504, 506, 508, 510 and 512 are clearly curved.

It is understood and appreciated that the initial base image may at times also include curved elements. Even in such instances, the adjusted image components that are based on the initial image components representing such curved elements will be distorted and distinctly different in comparison to the initial image components. Indeed, in at least one embodiment, the variance between each initial image component and the corresponding adjusted image component is determined and evaluated to insure distinction.

It is also to be appreciated that in at least one embodiment, at least one adjusted image component obscures at least a portion of another image component, such between adjusted image components 506 and 510 in area generally bounded by dotted circle 514. As used herein, “obscure” is understood to include the act of adjusted image element interfering with itself, interfering with another element, overlapping coincidence with another element, and/or intersection with itself or another element.

Moreover, in at least one embodiment, provided is a representation symbol 500 of a base image symbol 300 having a plurality of initial image components 302, 304, 306, 308, 310 and 312. The representation symbol 500 provided by a plurality of adjusted image components 502, 504, 506, 508, 510 and 512, each adjusted image component corresponding 502, 504, 506, 508, 510 and 512 to and offset from an initial image component 302, 304, 306, 308, 310 and 312; and at least one adjusted image component obscuring at least a portion of another adjusted image component.

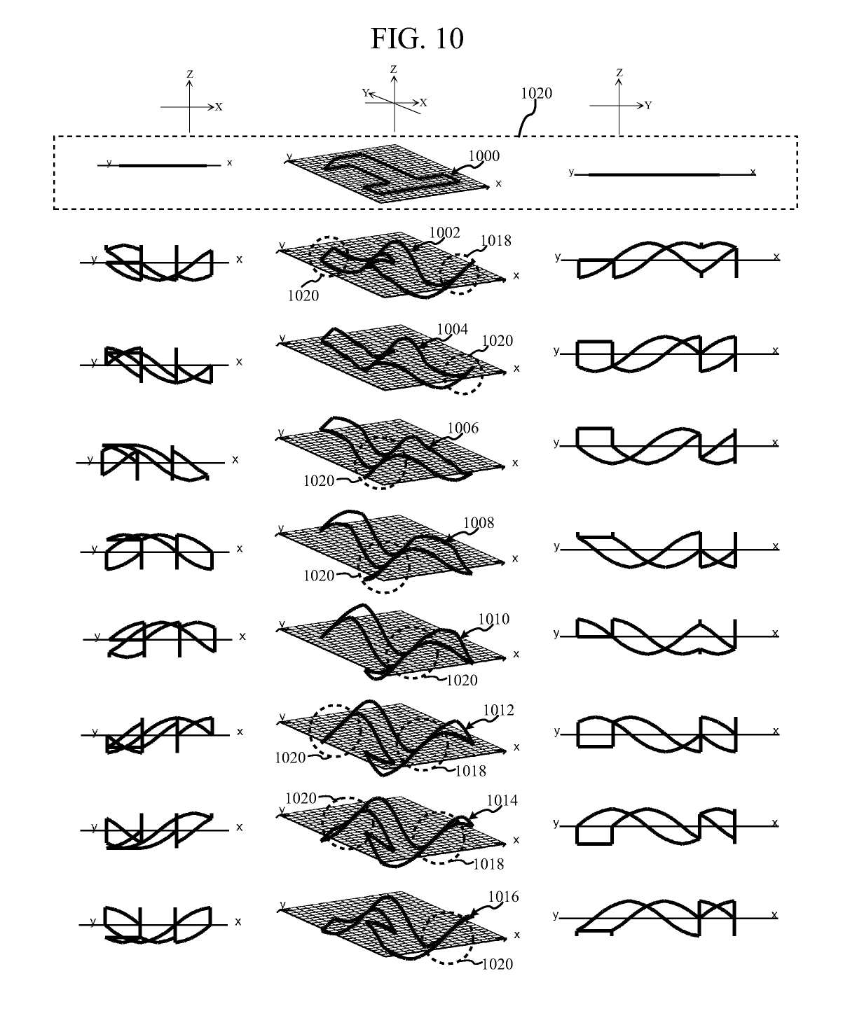

The perspective angle chosen for first plane 322 has been selected for ease of illustration and discussion with respect to appreciating the offsets as applied to the end points and control points. In at least one embodiment the first plane 322 would be angled so as to appear even flatter, which as a result would increase the perceived areas of overlap between one or more adjusted image components. Such an embodiment may be further appreciated with respect to FIG. 10 further discussed below, which clearly shows prominent areas of overlap between adjusted image components.

In at least one embodiment, each view of the representation symbol is provided by orthogonally projecting the collective adjusted image components into a viewing plane angled relative to the first plane 322. As used herein, projection into the viewing plane or onto the viewing plane is taken to be synonymous. This process is more fully described below, however to briefly state the matter, the viewing plane in at least one embodiment is defined to be the figure page itself. First plane 322 illustrated in the perspective is clearly angled relative to the page. Therefore, the representation image 500 is considered to be in three dimensions as it is shown with respect to the first plane 322.

The projection of representation image 500 into the viewing plane, e.g. the figure page, provides a view of the representation image 500 which is the representation of the initial base image symbol. Even with only six image elements the resulting representation image 500, and more specifically the corresponding view of representation image 500 is appreciated to be distorted in at least two dimensions. Further still, areas of perceived overlap between adjusted image components now insure that portions of one or more adjusted image components are obscured in the resulting view.

As used herein distortion in two dimensions is understood and appreciated to define more than a mere frame shift of an element from one location to another or the rotation of an element. In other words the distorted elements of the representation image can not be simply rotated or moved to impose upon their corresponding initial elements of the base image symbol.

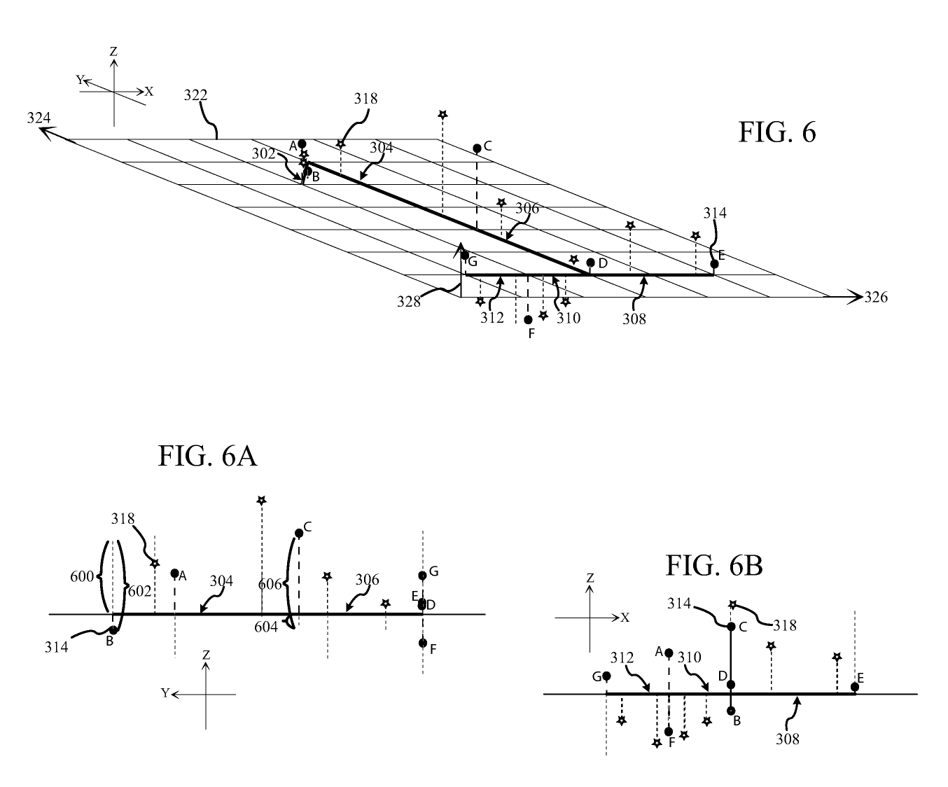

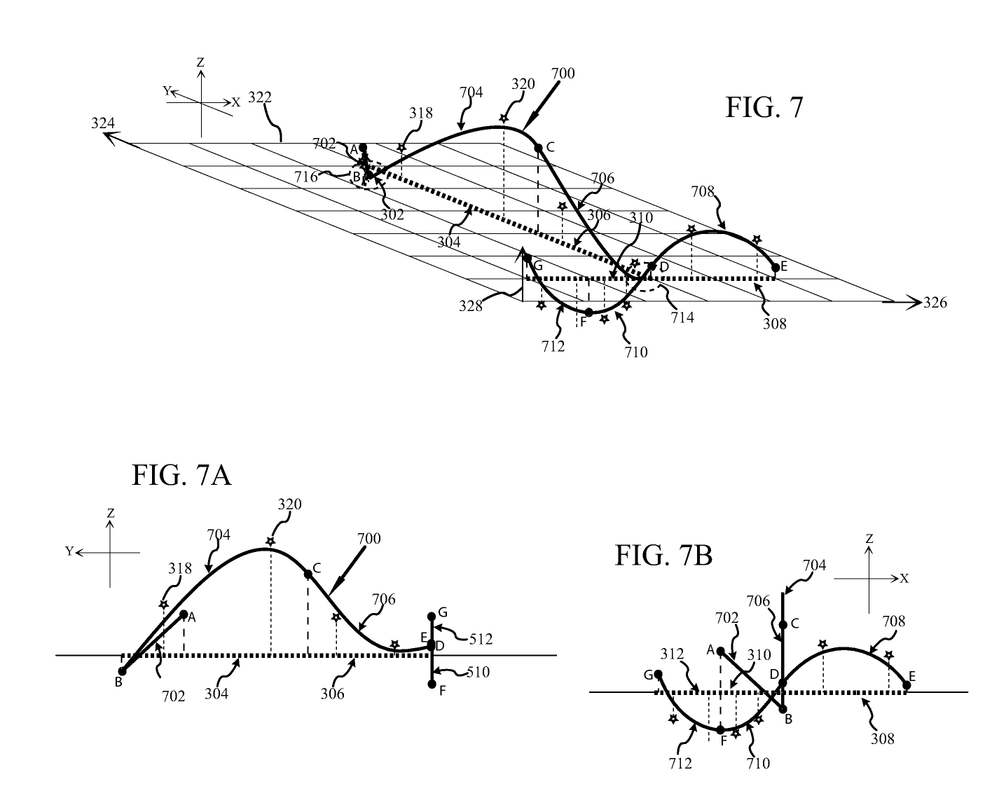

At least one advantage of SFGRS 100 and method 200 is that the representation symbol is presented as animation. The human mind is more attuned to pattern recognition and associative reasoning than a modern computer. Indeed, the adjusted image components collectively may so deviate from the initial base image that any one view taken in and of itself is difficult to recognize even for a human viewer. However, taken as an animated sequence, the human mind is able to quickly realize the underlying base image even when no key view is ever provided as a view. To accomplish this advantageous animated view of the representation symbol, additional views are generated as is conceptually illustrated in FIGS. 6 and 7.

FIG. 6 presents the same perspective view of first plane 322 as shown in FIGS. 3 and 5, and again illustrates new offsets for the first and second ends points 314A˜G as well as control points, of which control points 318 and 320 are exemplary. The side views along the X-axis, provided by FIG. 6A and the Y-axis, provided by FIG. 6B further indicate the relative change in the offsets from the first offsets shown in FIGS. 4-5B.

For example dotted line 600 shows the initial offset of endpoint 314B, which is now shown below first plane 322 as a result of new offset 602. Likewise endpoint 314C shown as below first plane 322 in FIGS. 4-5B with offset 604 is now shown in FIG. 6 to be considerably above first plane 322 due to offset 606. Indeed, in FIGS. 6, 6A and 6B end points 314A, B, C, E and G have moved considerably from their indicated positions in FIGS. 4-5. Likewise the control points have varied in offsets by varying degree as well.

Moreover, it is understood and appreciated that in at least one embodiment to provide a fluid appearance to the animation sequence, subsequent offsets for each respective end point and control point are determined from the immediately subsequent offset values. The offset values between FIGS. 5 and 6 have been exaggerated for illustrative and discussion purposes.

As with FIG. 5, FIG. 7 conceptually illustrates the Bézier curves rendered to provide the adjusted image components 702, 704, 706, 708, 710 and 712, which collectively provide representation symbol 700. The initial image components 302, 304, 306, 308, 310 and 312 shown in dotted line relief in first plane 322.

The adjusted image components 702, 704, 706, 708, 710 and 712 may be further appreciated with respect to FIG. 6A showing the adjusted image components 702, 704, 706, 708, 710 and 712 as viewed along the X-axis to perceive the YZ plane and FIG. 6B showing adjusted image components 702, 704, 706, 708, 710 and 712 as viewed along the Y-axis to perceive the ZX plane.

As in FIG. 5, at least one adjusted image component appears to obscure at least a portion of another image component, such between adjusted image components 706 and 710 in the area generally bounded by dotted circle 714. There is also a second instance of apparent overlap between adjusted image components 702 and 704 in the area generally bounded by dotted circle 716. In at least one embodiment, the noise function is selected to provide a predetermined number or degree of obscurances within each view.

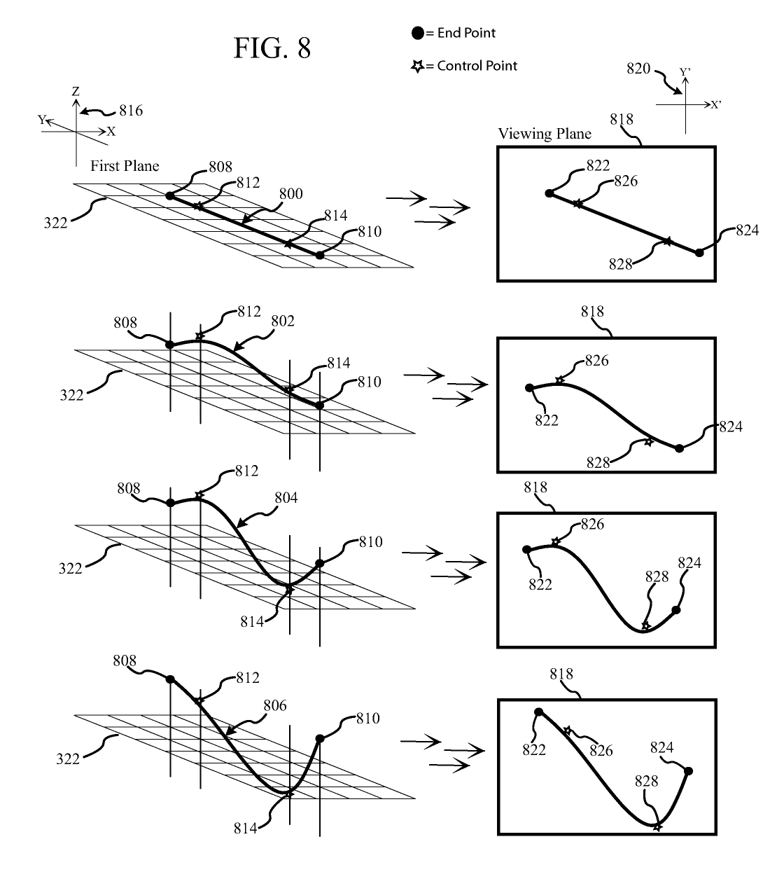

As indicated above, in at least one embodiment, each view is provided by orthogonally projecting the adjusted image components into a viewing plane angled relative to the first plane 322. FIG. 8 conceptually illustrates this orthogonal projection.

FIG. 8 shows four versions of a single image component, image component 800 being the initial image component, and image components 802, 804 and 806 being adjusted image components. As in FIGS. 4 and 6, end points the determined offsets applied to the first end point 808, the second end point 810 and control points 812, 814 are applied along the Z-axis.

In linear algebra and functional analysis, a projection is a linear transformation P from a vector space to itself such that P²=P. For example the function that maps the point (x,y,z) in three-dimensional space to the point (x,y,0) is a projection onto the X-Y plane. This function is represented by the matrix:

$$P = [ \begin{matrix}1 & 0 & 0 \\ 0 & 1 & 0 \\ 0 & 0 & 0\end{matrix} ]$$

wherein the action of the matrix on an arbitrary vector is

$$P ( \begin{matrix}x \\ y \\ z\end{matrix} ) = ( \begin{matrix}x \\ y \\ 0\end{matrix} )$$

Moreover, the orthogonal projection of the adjusted image components from the first plane 322 to the viewing plane 818 is a transformation achieved by matrix multiplication. As there is an angular difference between the first plane 322 and the viewing plane 818, the matrix is actually a 4×4 to 4×1 transformation.

The first plane 322 has a coordinate system, indicated by the X, Y, Z coordinate reference symbol 816. The viewing plane 818, which may also be considered the real world, also has a coordinate system that is effectively two dimensional indicated by the Y′, X′ coordinate reference symbol 820—the Z-axis being normal to the viewing plane 818.

The angular relationship between the first plane 322 and the viewing plane 818 is described in at least one embodiment by angles alpha “A”, beta “B” and gamma “Γ”. For the first plane 322 and viewing plane 818 as shown in FIG. 8 these angles are about alpha “A”=75 (difference in X-axis), beta “B”=0 (difference in Y-axis) and gamma “Γ”=−30 (difference in Z-axis).

With respect to FIG. 8, the progression of the coordinate values for first point 808, second point 810, first control point 812 and second control point 814 is shown in the following table:

| 1^{st} End | 1^{st} Control | 2^{nd} Control | 2^{nd} End |
|---|---|---|---|
| Point 808 | Point 812 | Point 814 | Point 810 |
| (x, y, z) | (x, y, z) | (x, y, z) | (x, y, z) |
| 2, 6, 0 | 2, 5, 0 | 2, 2, 0 | 2, 1, 0 |
| 2, 6, 1 | 2, 5, 2 | 2, 2, 1 | 2, 1, 0 |
| 2, 6, 2 | 2, 5, 3 | 2, 2, 0 | 2, 1, 2 |
| 2, 6, 3 | 2, 5, 2 | 2, 2, −1 | 2, 1, 3 |

In at least one embodiment, the transformation from the three dimensions of the first plane 322 to the viewing plane 818 occurs by first computing the rotational relationships between X′, Y′ and Z′ axis of the viewing plane 818 with the X, Y and Z axis of the first plane 322. This is performed by initializing three matrix, rotZ, rotY and rotX. An initial trans matrix (i.e., a translation matrix) may also be initialized. In at least one embodiment, there is a scale factor between the first plane 322 and the viewing plane, so an additional scale matrix may also be provided. Each end point and control point is also represented as a 1×4 matrix.

$$rotZ = [ \begin{matrix}cos Γ & - sin Γ & 0 & 0 \\ sin Γ & cos Γ & 0 & 0 \\ 0 & 0 & 1 & 0 \\ 0 & 0 & 0 & 1\end{matrix} ]$$

$$rotY = [ \begin{matrix}cos B & 0 & sin B & 0 \\ 0 & 1 & 0 & 0 \\ - sin B & 0 & cos B & 0 \\ 0 & 0 & 0 & 1\end{matrix} ]$$

$$rotX = [ \begin{matrix}1 & 0 & 0 & 0 \\ 0 & cos A & - sin A & 0 \\ 0 & sin A & cos A & 0 \\ 0 & 0 & 0 & 1\end{matrix} ]$$

$$scale = [ \begin{matrix}X & 0 & 0 & 0 \\ 0 & Y & 0 & 0 \\ 0 & 0 & Z & 0 \\ 0 & 0 & 0 & 0\end{matrix} ]$$

$$trans = [ \begin{matrix}1 & 0 & 0 & X \\ 0 & 1 & 0 & Y \\ 0 & 0 & 1 & Z \\ 0 & 0 & 0 & 1\end{matrix} ]$$

$$point = [ \begin{matrix}x \\ y \\ z \\ 1\end{matrix} ]$$

With respect to the example values of A=75, B=0 and Γ=−30, and first end point 808, the initial matrixes are:

$$rotZ = [ \begin{matrix}0.154251 & 0.387782 & 0 & 0 \\ - 0.387782 & 0.154251 & 0 & 0 \\ 0 & 0 & 1 & 0 \\ 0 & 0 & 0 & 1\end{matrix} ]$$

$$rotY = [ \begin{matrix}1 & 0 & 0 & 0 \\ 0 & 1 & 0 & 0 \\ 0 & 0 & 1 & 0 \\ 0 & 0 & 0 & 1\end{matrix} ]$$

$$rotX = [ \begin{matrix}1 & 0 & 0 & 0 \\ 0 & 0.921751 & - 0.387782 & 0 \\ 0 & 0.387782 & 0.921751 & 0 \\ 0 & 0 & 0 & 1\end{matrix} ]$$

$$1 st = [ \begin{matrix}2 \\ 6 \\ 0 \\ 1\end{matrix} ]$$

Initializing the viewing plane, e.g., real world is performed in at least one embodiment by successively multiplying the 4×4 matrixes of rotZ, rotY, rotX. In at least one embodiment multiplication by the 4×4 matrix of scale and trans is also included. The resulting product of the successive 4×4 transformations is then multiplied against the 1×4 matrix of each point, for example first end point 808.

With respect to FIG. 8, the transformation of the coordinate values for first point 808, second point 810, first control point 812 and second control point 814 from the first plane 322 to first end point 822, second end point 824, first control point 826 and second control point 828 the viewing plane 818 is shown in the following table:

| 1^{st} End Point 822 | 1^{st} Control Point 824 | 2^{nd} Control Point 826 | 2^{nd} End Point 824 |
|---|---|---|---|
| (x, y) | (x, y) | (x, y) | (x, y) |
| 4.73205, 1.08604 | 4.23205, 0.8619 | 2.73205, 0.189469 | 2.23205, −0.0346752 |
| 4.73205, 0.120118 | 4.23205, −1.06995 | 2.73205, −0.776457 | 2.23205, −1.0006 |
| 4.73205, −0.845807 | 4.23205, −2.03588 | 2.73205, 0.189469 | 2.23205, −1.96653 |
| 4.73205, −1.81173 | 4.23205, −1.06995 | 2.73205, 1.15539 | 2.23205, −2.93245 |

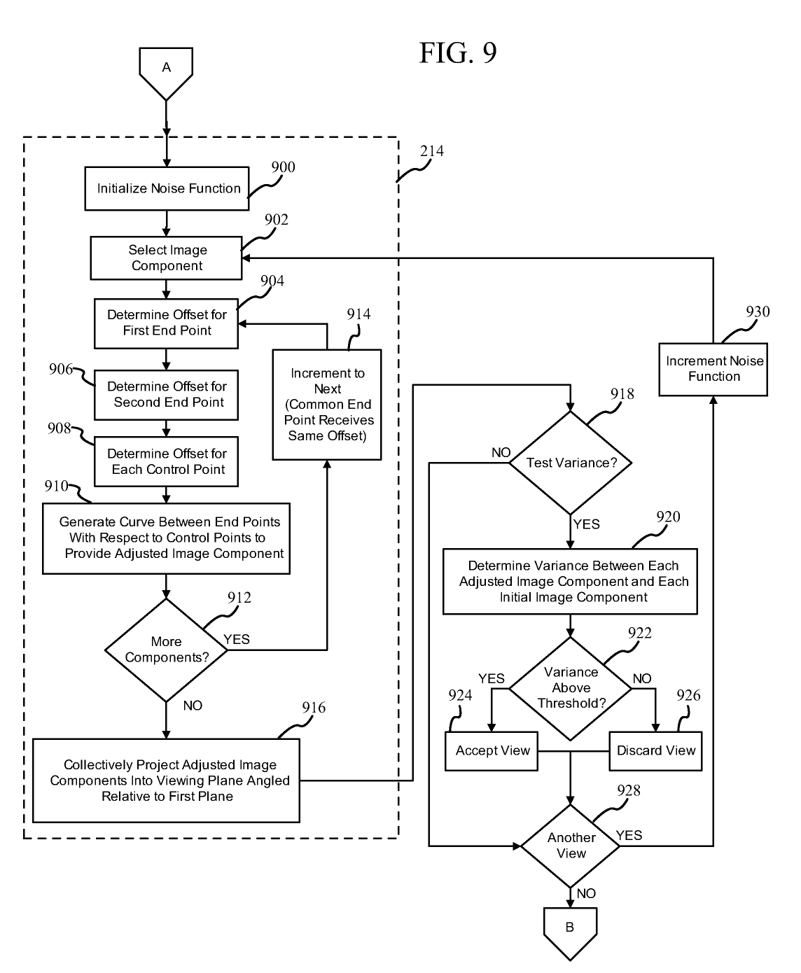

With respect to the flow diagram of FIG. 2, and the above description of the method with respect to FIGS. 3-8, FIG. 9 presents a high level flow diagram summarizing the key elements of generating the views as indicated in block 214, following the branch of reference point A. As with the flow diagram of FIG. 2, it is understood and appreciated that the refined method steps shown in FIG. 9 need not be performed in the order herein presented, but rather that the presented and described order is an example of at least one embodiment. Moreover, in accordance with the refined method elements shown in FIG. 9, in at least one embodiment, the selected noise function is initialized, block 900. A first image component is then selected, block 902.

The noise function is applied to determine the first offset for the first end point, block 904. Likewise the noise function is applied to determine the offset for the second end point, block 906 and to determine the offset for each control point, block 908. With the offsets so determined and applied, a curve is generated between the end points with respect to the control points to provide an adjusted image component, block 916.

If there are more image components remaining, decision 912, the method increments to the next image component, block 914. In at least one embodiment, common end points receive the same determined offset. To process the next adjusted image component the method returns to block 904.

When all image components have been adjusted, in at least one embodiment an option variance test is performed, decision 918. More specifically, to provide a representation of a base image symbol that truly poses a challenge for an automated bot, SFGRS 100 and method 200 are configured so as to not display a key view—a key view being a view that is substantially identical to the base image symbol. Further still, in at least one embodiment, in each respective view, portions of at least one adjusted image component obscure portions of at least one other adjusted image component. Depending on the base image symbol provided and the angular relationship between the first plane 322 and the viewing plane 818, it is possible that the orthogonal projection of the adjusted image components into the viewing plane 818 may be close to the initial base image.

To account for and thwart this possibility, an optional variance test is included in at least one embodiment. In at least one embodiment the variance is determined by comparing the vector of the adjusted image component to the vector of the corresponding initial image component, block 920. As each vector may be represented as a set of points, the similarity between the two vectors (S and S′) in at least one embodiment is defined by the following equation:

$$sim ( S , {S}^{′} ) = \frac{\vert S ⋂ {S}^{′} \vert}{\sqrt{\vert S \vert \cdot \vert {S}^{′} \vert}}$$

This equation provides a natural measure of similarity, wherein the result is “1” when the two sets are identical and “0” where they are disjointed. Moreover, where the adjusted image component vector is very similar to the initial image component vector the result will be close to “1”. Where the adjusted image component vector is dissimilar to the initial image component vector, the result will be close to “0”. In at least one embodiment a threshold of difference is defined such as for example a threshold of equal to or less than 0.65. When the comparison of the two vectors returns a value that is less than or equal to 0.65 the adjusted image component is classified as acceptable.

In at least one embodiment, the accepting or discarding of a view is determined by collectively evaluating all of the adjusted image components, decision 922. In at least one embodiment if the percentage of adjusted image components that are equal to or less than the selected threshold, the view will be valued as acceptable (a first instance), block 924, otherwise it is discarded (a second instance), block 926. In at least one embodiment the selected threshold is about thirty five percent. In at least one embodiment, in response to an accumulation of non-acceptable views over a defined percentage, the method will restart selecting a different angle or angles as between the first plane 322 and the viewing plane 818.

The variance comparison may be performed before orthogonal projection or after orthogonal projection depending on varying embodiment. It is of course realized that if the variance comparison is to be performed after orthogonal projection, an initial key view will be rendered for comparison purposes—but discarded and excluded from any set of output views.

With the variance test performed or avoided, the method tests to see if another view is desired, decision 928. In at least one embodiment such a decision is based on whether or not the noise function has cycled through an entire period. In at least one alternative embodiment such a decision is based on whether or not a specified period of time has elapsed.

In response to the request for additional views, decision 928, the noise function is incremented, block 930. With the noise function incremented the method returns to block 902 for the selection of an image component.

To briefly summarize, in at least one embodiment the method 200 of generating the representation symbol 500 of the base image symbol 300 includes, receiving the base image symbol 300 and distinguishing a plurality of initial image components 302, 304, 306, 308, 310 and 312 from the base image symbol 300. The initial image components 302, 304, 306, 308, 310 and 312 are mapped to a first plane defined by a first and second axis 324, 326, a third axis 328 being normal to the first plane 322. At least one noise function is selected. A plurality of views are generated, each view provided by applying the selected noise function to each initial image component to provide an adjusted image component, each adjusted image component offset from the initial image component. The collective adjusted image components are orthogonally projected into a viewing plane angled relative to the first plane 322. The plurality of views are then output.

Further still, in at least one embodiment, the method 200 of generating the representation symbol 500 of the base image symbol 300 includes, receiving the base image symbol and resolving a plurality of initial image components 302, 304, 306, 308, 310 and 312 from the base image symbol 300. At least one noise function is selected. A plurality of views are generated, each view provided by applying the selected noise function to each initial image component to provide an adjusted image component. The variance between the adjusted image component and the initial image component is determined, block 920. The view is accepted in a first instance, block 924, when the variance of a first percentage of the adjusted image components is above a first threshold value. The view is discarded in a second instance, block 926, when the variance of the first percentage of the adjusted image components is below the first threshold value. The plurality of views are then output.

In FIGS. 3-7 a relatively simple initial base image symbol has been used for illustration and discussion purposes—that of a line figure “1”. The complexity of distortion advantageously achieved in the adjusted image components increases tremendously when more complex base image symbols are used, and/or when the base image symbol is distinguished into a greater plurality of initial image components which in turn permits a greater number of adjusted image components.

FIG. 10 illustrates this affect on a base image symbol corresponding to a block “1” 1000 as provided by a functional SFGRS 100 in accordance with at least one embodiment. The noise function is based on sine, and more specifically is substantially as that presented above with the images shown for twenty degree increments. The first images, segregated by dotted box 1020 are the unadjusted image, e.g., key view for element 1000, which are provided only for illustrative purposes in appreciating the adjustments shown in each successive view provided by the collective adjusted image elements, generated representations 1002, 1004, 1006, 1008, 1010, 1012, 1014 and 1016. Corresponding side views and bottom views are provided as well so as to further appreciate the degree of offsets as applied.

The plane of the page itself is intended to correspond to the viewing plane. As such each generated representation 1002, 1004, 1006, 1008, 1010, 1012, 1014 and 1016 is also considered to be a view, e.g., views 1002, 1004, 1006, 1008, 1010, 1012, 1014 and 1016.

As is easily appreciated by visual inspection, no single view 1002, 1004, 1006, 1008, 1010, 1012, 1014 and 1016 substantially matches to base image 1000. Indeed a trace of the outline, superimposing multiple views, and/or optical character recognition as other such methods of pattern recognition used to identify images will not reveal a key view, or in some trivial way combine to suggest a key view.

With respect to FIG. 10 and the presented views 1002, 1004, 1006, 1008, 1010, 1012, 1014 and 1016, the advantageous issue of perceived overlap between adjusted image components is also more fully appreciated. Present in all views save the key view view, prominent and varying areas of overlap are identified by dotted circles 1018 and/or 1020 in each view. These areas of overlap, and the resulting obscurity of portions of one or more adjusted image components, advantageously adds a heightened level of complexity to each presented view 1002, 1004, 1006, 1008, 1010, 1012, 1014 and 1016.

Indeed, the multiple apparent bounded areas and disappearing and reappearing elements significantly increase the challenge posed by the representations of the base image symbol 1000 when perceived by a bot or other automated agent. Just the same, the human mind is capable of quickly abstracting each view to perceive the representations for the base image symbol 1000, that of a block outline “1”.

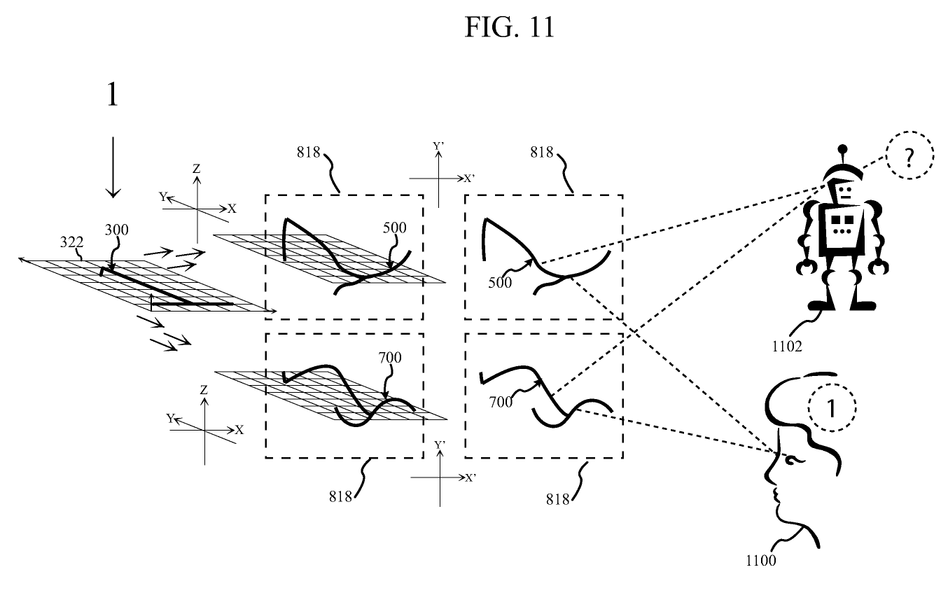

FIG. 11 conceptually summarizes the above discussion. More specifically, a base image symbol 300, e.g. a “1” is provided and mapped to a first frame 322 as a plurality of initial image components. Application of at least one noise function provides the rendering of adjusted image components, which collectively provide representations 500 and 700 of the initial base image 300. These collective representations 500 and 700 are orthogonally projected into a viewing plane that is angled relative to the first plane 322. With respect to FIG. 11, the viewing plane and the plane of the figure page are intended to be the same.

As an animation, the resulting views are received by a human 1100 and understood to be representations of the initial base symbol, e.g., “1”. If the same views are perceived by an automated agent 1102, the complexity of the adjustments to the image components and the resulting distortion in the views is confounding. In other words the resulting views are human only perceptible (HOP), and pose an advantageous challenge to an automated agent 1102. Indeed, with respect to FIG. 11 it is clearly understood and appreciated that each representation symbol 500 and 700 is composed of adjusted image components that are in essence distortions of the initial image components.

Moreover, the adjusted image components clearly indicate two dimensional distortion that is substantially more complex then simple location shifting or scaling of an image component. In other words, this two dimensional distortion has transformed straight elements into curved elements. In the event that the initial base image consists of one or more curved elements as well, the adjusted image components would still be distinctly different curved elements due to the process of distinguishing a plurality of image components and deriving adjusted image components as discussed above.

It should also be understood and appreciated, that although the above description and accompanying figures present a single base image symbol, it is to be understood and appreciated that the SFGRS 100 and method 200 can be applied simultaneously to a plurality of base image symbols, such as a string of alphanumeric characters, e.g. “28088SPOT”. Indeed, as first suggested above although the base image symbol has been shown and discussed as a single element, in at least one embodiment the base image symbol consists of a plurality of definable characters and/or elements.

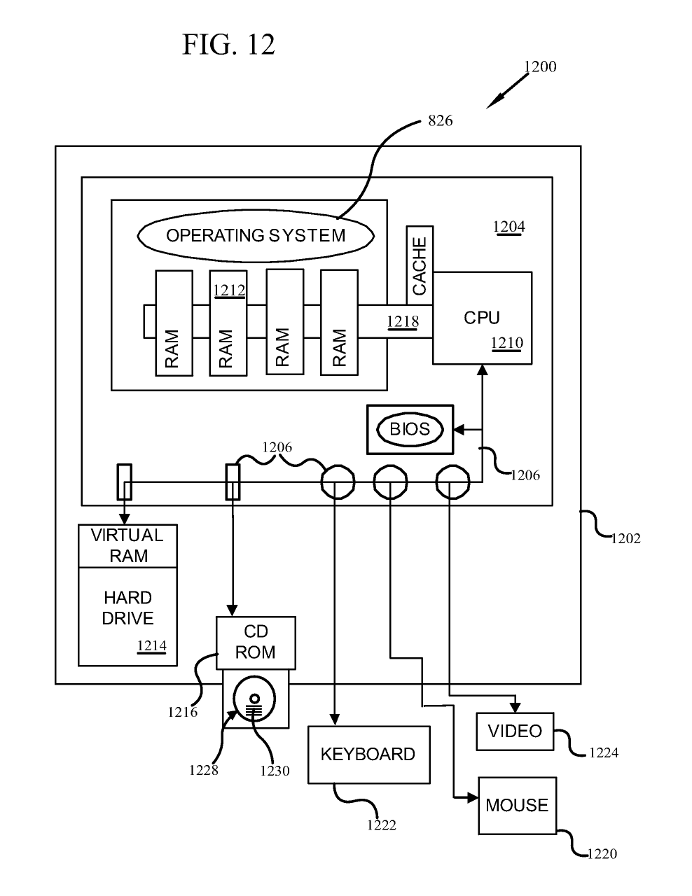

With respect to the above description of SFGRS 100 and method 200, with refinements illustrated in FIG. 9, it is understood and appreciated that the method may be rendered in a variety of different forms of code and instruction as may be preferred for different computer systems and environments. To expand upon the initial suggestion of a computer implementation suggested above, FIG. 12 is a high level block diagram of an exemplary computer system 1200. Computer system 1200 has a case 1202, enclosing a main board 1204. The main board has a system bus 1206, connection ports 1208, a processing unit, such as Central Processing Unit (CPU) 1210, and a memory storage device, such as main memory 1212, hard drive 1214, and CD/DVD Rom drive 1216.

Memory bus 1218 couples main memory 1212 to CPU 1210. A system bus 1206 couples hard drive 1214, CD/DVD Rom drive 1216, and connection ports 1208 to CPU 1210. Multiple input devices may be provided, such as for example a mouse 1220 and keyboard 1222. Multiple output devices may also be provided, such as for example a video monitor 1224 and a printer (not shown).

Computer system 1200 may be a commercially available system, such as a desktop workstation unit provided by IBM, Dell Computers, Gateway, Apple, Sun Micro Systems, or other computer system provider. Computer system 1200 may also be a networked computer system, wherein memory storage components such as hard drive 1214, additional CPUs 1210 and output devices such as printers are provided by physically separate computer systems commonly connected together in the network. Those skilled in the art will understand and appreciate that physical composition of components and component interconnections comprising computer system 1200, and select a computer system 1200 suitable for the schedules to be established and maintained.

When computer system 1200 is activated, preferably an operating system 1226 will load into main memory 1212 as part of the boot strap startup sequence and ready the computer system 1200 for operation. At the simplest level, and in the most general sense, the tasks of an operating system fall into specific categories—process management, device management (including application and user interface management) and memory management.

In such a computer system 1200, the CPU 1210 is operable to perform one or more of the methods of representative symbol generation described above. Those skilled in the art will understand that a computer-readable medium 1228 on which is a computer program 1230 for generating representation symbols may be provided to the computer system 1200. The form of the medium 1228 and language of the program 1230 are understood to be appropriate for computer system 1200. Utilizing the memory stores, such as for example one or more hard drives 1214 and main system memory 1212, the operable CPU 1202 will read the instructions provided by the computer program 1230 and operate to perform the scheduling system 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method of generating a representation of a symbol, the method comprising:
receiving a base image symbol;
distinguishing a plurality of initial image components from the base image symbol mapped to a first plane defined by a first and second axis, a third axis being normal to the first plane;
selecting at least one noise function;
generating a plurality of views, each view provided by:
applying the selected noise function to each initial image component to provide an adjusted image component, each adjusted image component offset from initial image component;
orthogonally projecting the collective adjusted image components into a viewing plane angled relative to the first plane;
outputting the plurality of views for the viewing plane.

2. The method of claim 1, wherein distinguishing each initial image component comprises:
subdividing the base image into a plurality of elements, each element having a first end point, a second end point, at least two control points therebetween and a vector line from the first end point to the second end.

3. The method of claim 2, wherein applying the noise function to provide adjusted image components for each view comprises:
determining an offset for each first end point, second end point and control points of each element along at least one axis;
adding the determined offset to each first end point, second end point and control points of each element along the at least one axis, common end points between elements receiving the same offset;
regenerating the vector between each set of the first and second end points as a curve.

4. The method of claim 3, wherein the determined offsets for the control points of each element are out of phase with the determined offsets for the first and second end points of each element.

5. The method of claim 3, wherein the offset axis is transverse the first plane.

6. The method of claim 3, wherein the offset axis is within the first plane.

7. The method of claim 1, wherein at least two different noise functions are selected, each applied to a different subset of initial image components.

8. The method of claim 1, wherein for each view, at least one adjusted image component obscures at least a portion of another adjusted image component.

9. The method of claim 1, wherein in response to the base image symbol having symbol identity information, removing the symbol identity information.

10. The method of claim 1, wherein the plurality of views are output to a database.

11. The method of claim 1, wherein the plurality of views are output to a display mechanism.

12. The method of claim 1, wherein the plurality of views are human only perceptible (HOP).

13. The method of claim 1, the plurality of views posing an identification challenge for an automated agent.

14. The method of claim 1, further including:
determining a variance between the adjusted image component and the initial image component; and
accepting the view in a first instance when the variance of a first percentage of the adjusted image components is above a first threshold value, and discarding the view in a second instance when the variance of the first percentage of the adjusted image components is below the first threshold value.

15. The method of claim 14, wherein the first percentage is at least about thirty-five percent and the first threshold is at least about thirty-five percent.

16. The method of claim 1, wherein the method is stored on a computer-readable medium as a computer program which, when executed by a computer will perform the steps of generating a representation of a symbol, the generated representation posing a challenge for an automated agent.

17. A representation symbol of a base image symbol having a plurality of initial image components, comprising:
a plurality of adjusted image components, each adjusted image component corresponding to and offset from an initial image component; and
at least one adjusted image component obscuring at least a portion of another adjusted image component.

18. The representation symbol of claim 17, wherein the plurality of adjusted image components are a view, a plurality of different views providing an animation.

19. The representation symbol of claim 17, provided by:
receiving the base image symbol;
distinguishing the base image symbol into the plurality of initial image components mapped to a first plane;
selecting at least one noise function; and
generating a view of the representation symbol by:
applying the selected noise function to each initial image component to provide each corresponding adjusted image component, each adjusted image component offset from the corresponding initial image component; and
orthogonally projecting the collective adjusted image components into a viewing plane angled relative to the first plane.

20. The representation symbol of claim 17, provided by:
receiving the base image symbol;
resolving the base image symbol into the plurality of initial image components;
selecting at least one noise function; and
generating a view of the representation symbol by:
applying, for each initial image component, the selected noise function to provide an adjusted image component;
determining a variance between the adjusted image component and the initial image component; and
accepting the view in a first instance when the variance of a first percentage of the adjusted image components is above a first threshold value, and discarding the view in a second instance when the variance of the first percentage of the adjusted image components is below the first threshold value.

21. A method of generating a representation of a symbol that poses an identification challenge for an automated agent, the method comprising:
receiving a base image symbol;
resolving the base image symbol into a plurality of initial image components;
selecting at least one noise function;
generating a plurality of views, each view provided by:
applying, for each initial image component, the selected noise function to provide an adjusted image component;
determining a variance between the adjusted image component and the initial image component;
accepting the view in a first instance when the variance of a first percentage of the adjusted image components is above a first threshold value, and discarding the view in a second instance when the variance of the first percentage of the adjusted image components is below the first threshold value; and
outputting the plurality of views.

22. The method of claim 21, wherein the plurality of initial image components are mapped to a first plane defined by a first and second axis, a third axis being normal to the plane, each adjusted image component offset from the initial image component and orthogonally projected into a viewing plane angled relative to the first plane.

23. The method of claim 22, wherein for each view, at least one adjusted image component obscures at least a portion of another adjusted image component.

24. The method of claim 21, wherein resolving each initial image component comprises:
subdividing the base image into a plurality of elements, each element having a first end point, a second end point, at least two control points therebetween and a vector line from the first end point to the second end.

25. The method of claim 24, wherein applying the noise function to provide adjusted image components comprises:
determining an offset for each first end point, second end point and control points of each element along at least one axis;
adding the determined offset to each first end point, second end point and control points of each element along the at least one axis, common end points between elements receiving the same offset; and
regenerating the vector between each set of the first and second end points as a curve.

26. The method of claim 21, wherein the first percentage is at least about thirty-five and the first threshold is at least about percent.

27. The method of claim 26, wherein the first percentage is about fifty percent and the first threshold is about fifty percent.

28. The method of claim 21, wherein the plurality of views are output in a first instance to a database and in a second instance to a display mechanism.

29. The method of claim 21, wherein the selected noise function has a repeating period, the plurality of views generated over one instance of the period.

30. The method of claim 21, wherein the method is stored on a computer-readable medium as a computer program which, when executed by a computer will perform the steps of generating a representation of a symbol, the generated representation posing a challenge for an automated agent.

31. A system for generating a representation of a symbol, comprising:
a receiver structured and arranged with an input device for permitting at least one base image symbol to be received;
a distinguisher structured and arranged to distinguish a plurality of initial image components from the base image symbol mapped to a first plane defined by a first and second axis, a third axis being normal to the first plane;
a noise function structured and arranged to provide at least one noise function;
a view generator structured and arranged to generate a plurality of views, each view provided by:
applying the selected noise function to each initial image component to provide an adjusted image component, each adjusted image component offset from the initial image component;
orthogonally projecting the collective adjusted image components into a viewing plane angled relative to the first plane;
an outputter structured and arranged to output the plurality of views for the viewing plane.

32. The system of claim 31, wherein at least one adjusted image component obscures at least a portion of another adjusted image component in each view.

33. The system of claim 31, wherein the system further includes:
a processing unit;
a memory storage device coupled to the processing unit;
an input device coupled to the processing unit and operable to receive a base image symbol;
an output device coupled to the processing unit;
the processing unit being operative to execute instructions for the generation of representations of the base image symbol; and
wherein the receiver is a receiving routine operatively associated with an input device for permitting the least one base image symbol to be received;
the distinguisher is a distinguishing routine for distinguishing the plurality of initial image components from the base image symbol mapped to the first plane defined by the first and second axis, the third axis being normal to the first plane;
the noise function is a noise function routine for providing the at least one noise function;
the view generator is a generate views routine for generating the plurality of views, each view provided by:
applying the selected noise function to each initial image component to provide an adjusted image component, each adjusted image component offset from the initial image component;
orthogonally projecting the collective adjusted image components into the viewing plane angled relative to the first plane;
the outputter is an output routine for outputting the plurality of views for the viewing plane.

34. A computer-readable medium on which is stored a computer program for generating a representation of a symbol as a challenge for an automated agent, the computer program comprising instructions which when executed by a computer, perform the steps of:
receiving a base image symbol;
distinguishing a plurality of initial image components from the base image symbol mapped to a first plane defined by a first and second axis, a third axis being normal to the first plane;
selecting at least one noise function;
generating a plurality of views, each view provided by:
applying the selected noise function to each initial image component to provide an adjusted image component, each adjusted image component offset from initial image component;
orthogonally projecting the collective adjusted image components into a viewing plane angled relative to the first plane;
outputting the plurality of views for the viewing plane.

35. The computer-readable medium of claim 34, wherein for each view, at least one adjusted image component obscures at least a portion of another adjusted image component.

36. The computer-readable medium of claim 34, wherein distinguishing each initial image component comprises:
subdividing the base image into a plurality of elements, each element having a first end point, a second end point, at least two control points therebetween and a vector line from the first end point to the second end.

37. The computer-readable medium of claim 34, wherein applying the noise function to provide adjusted image components for each view comprises:
determining an offset for each first end point, second end point and control points of each element along at least one axis;
adding the determined offset to each first end point, second end point and control points of each element along the at least one axis, common end points between elements receiving the same offset;
regenerating the vector between each set of the first and second end points as a curve.

38. The computer-readable medium of claim 34, further including:
determining a variance between the adjusted image component and the initial image component; and
accepting the view in a first instance when the variance of a first percentage of the adjusted image components is above a first threshold value, and discarding the view in a second instance when the variance of the first percentage of the adjusted image components is below the first threshold value.
